(19) United States
(12) Patent Application Publication
(10) Pub. No.: US 2025/0238810 A1
(43) Pub. Date: Jul. 24, 2025

(54) METHODS AND SYSTEMS FOR CERTIFYING CARBON CREDITS FOR ELECTRIC VEHICLE CHARGING

(71) Applicant: Climate Resources Exchange International Pte. Ltd., Singapore (SG)

(72) Inventor: Vinod KESAVA, Singapore (SG)

(21) Appl. No.: 18/855,288

(22) PCT Filed: Apr. 5, 2023
(86) PCT No.: PCT/SG2023/050234

§ 371 Date: Oct. 8, 2024

(30) Foreign Application Priority Data
Apr. 8, 2022 (SG) 10202203651T

(51) Int. Cl. G06Q 30/018; G06Q 20/40; G06Q 50/06

(52) U.S. Cl. CPC G06Q 30/018; G06Q 20/401; G06Q 50/06; G06Q 2220/00

(57) ABSTRACT

The present disclosure generally relates to a methods and systems for certifying carbon credits for electric vehicle charging. One or more carbon credit eligible parties are identified using an indication of an electric vehicle charging event and/or a payment record corresponding to the electric vehicle charging event. An amount of carbon credits is calculated, and a carbon credit certificate is generated. The carbon credit certificate indicates the one or more carbon credit eligible parties, the amount of carbon credits, and a unique identifier of the electric vehicle charging event.

### CROSS REFERENCE TO RELATED APPLICATIONS

The present disclosure claims the benefit of Singapore patent application Ser. No. 10202203651T filed on 8 Apr. 2022, which is incorporated in its entirety by reference herein.

### TECHNICAL FIELD

The present disclosure generally relates to methods and systems for certifying carbon credits for electric vehicle charging.

### BACKGROUND

Carbon credits are tradeable certificates that permit emission of a predefined amount of carbon dioxide or the equivalent amount of other greenhouse gases (CO2e). One carbon credit is equivalent to one tonne of carbon dioxide or CO2e. Projects that reduce carbon emissions are financed to generate carbon credits. Heavy emitters can purchase carbon credits to offset their carbon emissions in order to meet compliance policies or government regulations. Carbon credits once retired cannot be reused.

Carbon credits must meet international standards, such as the Verra Verified Carbon Standard or the Gold Standard, that ensure the carbon offsets truly reduce the amount of greenhouse gases in the atmosphere and contribute to carbon neutrality goals. Currently, it is difficult for individual parties, especially users of electric vehicles, to earn carbon credits from charging their electric vehicles which reduce carbon emissions. Another problem is the risk of fraudulent practices such as double counting of carbon credits, which would allow the same carbon credit to be used to offset the carbon emissions of more than one party.

Therefore, in order to address or alleviate at least one of the aforementioned problems and/or disadvantages, there is a need to provide improved methods and systems for certifying carbon credits for electric vehicle charging.

### SUMMARY

According to a first aspect of the present disclosure, there is a computer implemented method for certifying carbon credits for electric vehicle charging. The method comprises: receiving an indication of an electric vehicle charging event and a payment record corresponding to the electric vehicle charging event; identifying one or more carbon credit eligible parties using the indication of the electric vehicle charging event and/or the payment record; calculating an amount of carbon credits for the electric vehicle charging event using the indication of the electric vehicle charging event; generating a carbon credit certificate indicating the one or more carbon credit eligible parties, the amount of carbon credits, and a unique identifier of the electric vehicle charging event.

According to a second aspect of the present disclosure, there is a computer system comprising a processor and a data storage device. The data storage device stores computer program instructions operable to cause the processor to perform the computer implemented method.

Methods and systems for certifying carbon credits for electric vehicle charging are thus disclosed herein. Various features, aspects, and advantages of the present disclosure will become more apparent from the following detailed description of the embodiments of the present disclosure, by way of non-limiting examples only, along with the accompanying drawings briefly described below.

### BRIEF DESCRIPTION OF THE DRAWINGS

FIG. 1 is a schematic illustration of a system for certifying carbon credits for electric vehicle charging.

FIG. 2 is an illustration of a communications protocol for electric vehicle charging.

FIG. 3 is an illustration of an application running on a user device.

FIG. 4 is an illustration of a carbon credit certificate.

FIG. 5 is flowchart illustration of a method for certifying carbon credits for electric vehicle charging.

FIG. 6 is flowchart illustration of another method for certifying carbon credits for electric vehicle charging.

FIGS. 7A to 7C are illustrations of some scenarios of electric vehicle charging.

FIGS. 8A to 8L are illustrations of further scenarios of electric vehicle charging.

### DETAILED DESCRIPTION

For purposes of brevity and clarity, descriptions of embodiments of the present disclosure are directed to methods and systems for certifying carbon credits for electric vehicle charging, in accordance with the drawings. While parts of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of features of particular embodiments. In a number of instances, well-known systems, methods, procedures, and components have not been described in detail so as to not unnecessarily obscure features of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment. As used herein, the terms “a” and “an” are defined as one or more than one. The use of “/” in a figure or associated text is understood to mean “and/or” unless otherwise indicated. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

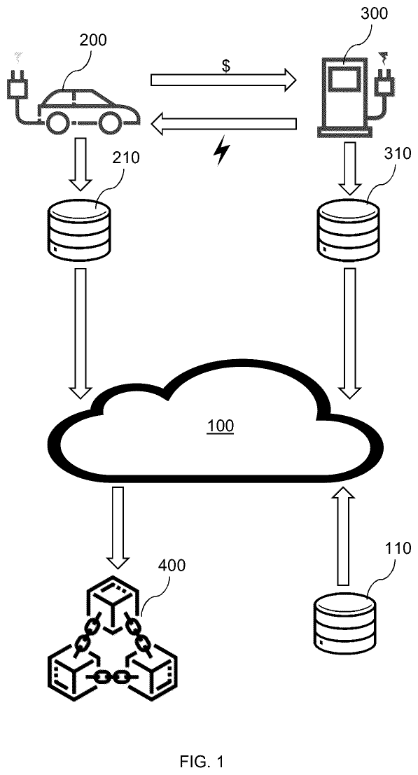

Representative or exemplary embodiments of the present disclosure describe a computer system 100 and computer implemented method for certifying carbon credits for electric vehicle charging, with reference to FIG. 1. The computer system 100 includes a processor and a data storage device, the data storage device storing computer program instructions operable to cause the processor to perform the computer implemented method. The computer system may be a physical or cloud data processing system on which a server program runs. The computer system may be implemented in hardware or software, or a combination thereof. Some non-limiting examples of the computer system include computers, laptops, mini-computers, mainframe computers, any non-transient and tangible machines that can execute a machine-readable code, cloud-based servers, distributed server networks, and a network of computers. It will be appreciated that the processor includes suitable logic, circuitry, and/or interfaces to execute operations or steps of the method. Some non-limiting examples of the processor include an application-specific integrated circuit (ASIC) processor, a reduced instruction set computing (RISC) processor, a complex instruction set computing (CISC) processor, a field-programmable gate array (FPGA), and the like. Further, instructions may be executed by a processor simultaneously, serially, or otherwise executed by one or multiple processors (e.g. in a multi-core configuration).

Electric vehicles 200 are motorised vehicles that use electricity for propulsion. Electric vehicles 200 can be charged at charging stations or points 300, or electric vehicle chargers, where electricity is supplied from the power grid. Operators of charging points 300 (CPOs) and fleet owners and operators (FOs) of electric vehicles 200 contribute to the electric vehicle charging infrastructure and drive the transformation of the automotive industry. A fleet owner is a party that owns a fleet of electric vehicles 200 and may directly operate the electric vehicles 200. A fleet operator is a party that operates electric vehicles 200 that are owned by another party (fleet owner). CPOs are parties that own and operate electric vehicle chargers 300. CPOs and FOs may participate in various initiatives that facilitates adoption of electric mobility and contribute to carbon neutrality goals and generate revenue from carbon credits. One example of such initiatives is the Electric Vehicle Acceleration Grouped Project (EVA), as described further below.

When an electric vehicle 200 is plugged to a charging point or electric vehicle charger 300, an electric vehicle charging event occurs, wherein electricity is transferred from the charger 300 to the electric vehicle 200. The user of the electric vehicle 200 makes a payment to the charger 300 for the electricity. Records of the electric vehicle charging event and the payment are sent to a charger database 310 of the CPO of the charger 300. Additionally or alternatively, records of the electric vehicle charging event and the payment may be sent to a fleet database 210 of the FO of the electric vehicle 200. For example, an application running on a user device 250 or on the electric vehicle 200 sends the information to the fleet database 210.

It will be appreciated that the charger database 310 may be communicative with various chargers 300 under the same CPO to record various electric vehicle charging events and payment records. Similarly, the fleet database 210 may be communicative with various electric vehicles 200 under the same FO.

After the electric vehicle charging event, the computer system 100 receives an indication of the electric vehicle charging event and the payment record corresponding to the electric vehicle charging event. For example, the CPO of the charger 300 is partnered with the computer system 100 and sends the information from the charger database 310. Additionally or alternatively, the FO of the electric vehicle 200 is partnered with the computer system 100 and sends the information from the fleet database 210.

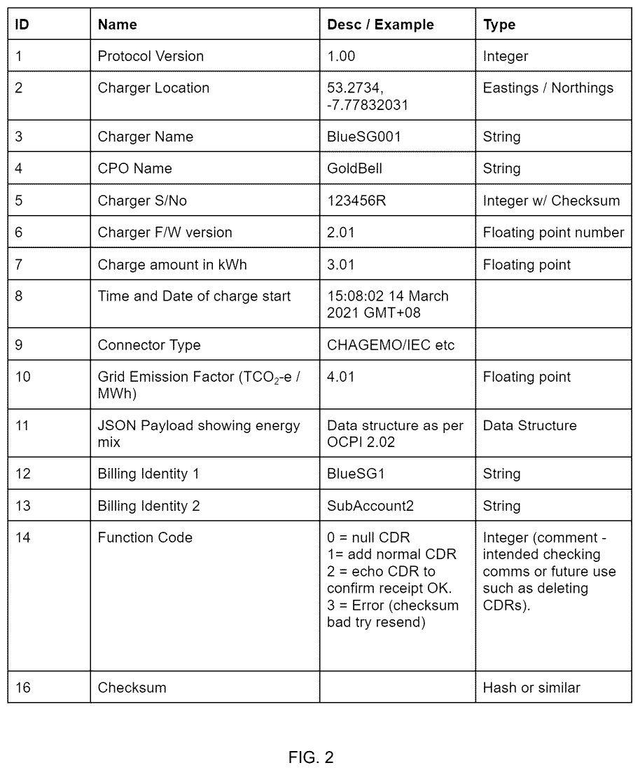

The computer system 100 includes a member database 110 that identifies which electric vehicles 200 and chargers 300 are members of any initiatives for adoption of electric mobility, such as EVA. The indication of the electric vehicle charging event is sent to the computer system 100 based on a suitable communications protocol for electric vehicle charging. One example of a known communications protocol is the Open Charge Point Interface (OCPI) protocol. Preferably, as shown in FIG. 2, the communications protocol includes additional data points that allow recognition of different geographical regions that have different electricity sources with different emissions, such as different ASEAN countries. For example, the additional data points include a grid emission factor. The communications protocol with the additional data points may be referred to as the Beyond OCPI (BCPI) protocol.

In some first embodiments, the indication of the electric vehicle charging event and the payment record corresponding to the electric vehicle charging event are received from an electric vehicle charger 300. The CPO of the charger 300 allows the computer system 100 to access the charger database 310 to receive the indication of the electric vehicle charging event and the payment record.

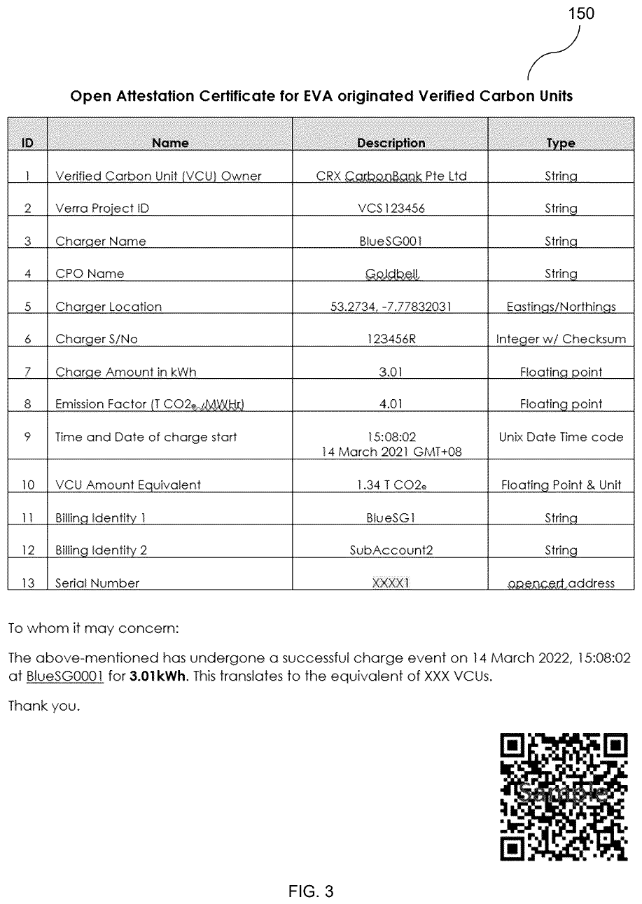

In some second embodiments as shown in FIG. 3, the indication of the electric vehicle charging event and the payment record corresponding to the electric vehicle charging event are received from the application running on the user device 250 or on the electric vehicle 200. The user device 250 is operated by the user of the electric vehicle 200, and may include mobile devices such as mobile phones and tablets. The application may also be in-built into the electric vehicle 200. The application records the indication of the electric vehicle charging event and stores the payment record once the payment has been made. For example, the user may use a payment application on the user device 250 to make the payment. The computer system 100 then receives the indication of the electric vehicle charging event and the payment record from the application. The FO of the electric vehicle 200 allows the computer system 100 to access the fleet database 210 to receive the indication of the electric vehicle charging event and the payment record.

In both the first and second embodiments, the computer system 100 creates a unique event record that links an identifier of the charger 300 to a billing identifier from the payment record. The computer system 100 also identifies whether the charger 300 and the electric vehicle 200 are members of EVA. Preferably, the computer system also verifies that the payment record corresponds to the electric vehicle charging event. For example, said verifying may include comparing metadata of the payment record with the indication of the electric vehicle charging event.

Comparing the metadata provides verification that the electric vehicle charging event is unique, since a single charging event should be linked to a single payment record, to prevent double counting of carbon credits. The metadata includes an identifier of the user, who is the person making the payment and the user of the charging event. The metadata further includes the payment amount, charging amount (electricity used), as well as the date and time of the charging event.

After receiving the indication of the electric vehicle charging event and the payment record, the computer system 100 identifies one or more carbon credit eligible parties using the indication of the electric vehicle charging event and/or the payment record. The carbon credit eligible parties may include the CPO of the charger 300 and/or the user of the electric vehicle 200, as described in various scenarios further below. Identifying the one or more carbon credit eligible parties may include determining the billing identifier from the payment record and using the billing identifier to look up a record in the member database 110 corresponding to a billed party. The record in the member database 110 corresponding to the billed party may indicate a carbon credit allocation scenario and the one or more carbon credit eligible parties are identified according to the carbon credit allocation scenario.

For example, the billing identifier is used to look up the billed party in the member database 110. The billed party may be the FO of the electric vehicle 200. Based on the identity of the billed party, an appropriate carbon credit allocation scenario is determined for distributing the carbon credits and other benefits like cash incentives.

After identifying the one or more carbon credit eligible parties, the computer system 100 calculates an amount of carbon credits for the electric vehicle charging event using the indication of the electric vehicle charging event.

In one embodiment, the calculation of the amount of carbon credits may include determining the charging amount from the indication of the electric vehicle charging event and the grid emission factor corresponding to the electric vehicle charger 300 associated with the charging event, wherein the amount of carbon credits is calculated from the charging amount and the grid emission factor.

In one embodiment, the calculation of the amount of carbon credits may include determining the charging amount from the indication of the electric vehicle charging event and the emission reduction corresponding to the electric vehicle 200 associated with the charging event, wherein the amount of carbon credits is calculated from the charging amount and the emission reduction. The emission reduction may be determined from the difference between the baseline emission and the projected emission. The baseline emission is the amount of CO2e emitted from traditional vehicles using fossil fuels. The projected emission is the amount of CO2e emitted from electric vehicles 200 or hybrid vehicles using a combination of fossil fuels and electricity.

In one embodiment, the calculation of the amount of carbon credits may include determining the charging amount from the indication of the electric vehicle charging event, the grid emission factor corresponding to the electric vehicle charger 300 associated with the charging event, and the emission reduction corresponding to the electric vehicle 200 associated with the charging event, wherein the amount of carbon credits is calculated from the charging amount, the grid emission factor, and the emission reduction.

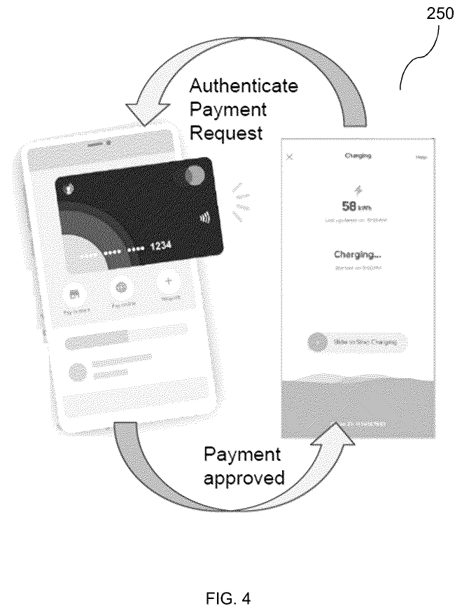

After calculating the amount of carbon credits, the computer system 100 generates a carbon credit certificate 150 indicating the one or more carbon credit eligible parties, the amount of carbon credits, and a unique identifier of the electric vehicle charging event. FIG. 4 shows an example of the carbon credit certificate 150.

The computer system 100 may store the carbon credit certificate 150 on a server or database, such as a centralized server. The server may be based on a centralized model, decentralized model, or hybrid model. The server is a physical or cloud data processing system on which a server program runs. The server may be implemented in hardware or software, or a combination thereof. Some non-limiting examples of the server include computers, laptops, mini-computers, mainframe computers, any non-transient and tangible machines that can execute a machine-readable code, cloud-based servers, distributed server networks, and a network of computers.

Preferably, the computer system 100 stores the carbon credit certificate 150 on a blockchain 400. The computer system 100 may optionally verify the carbon credit certificate 150 on the blockchain 400. The carbon credit certificates 150 that are stored on the blockchain 400 may also be referred to as non-fungible tokens.

The blockchain 400 is a decentralized, distributed database or ledger that is shared among the nodes of a computer network. The blockchain 400 is an immutable database and data that is stored on the blockchain 400, including the carbon credit certificates 150, cannot be manipulated. For example in Singapore, the carbon credit certificate 150 is compatible with OpenAttestation, which is an open-source framework for verification of documents using the blockchain 400. OpenAttestation makes use of smart contracts on the Ethereum blockchain to store cryptographic proof of documents.

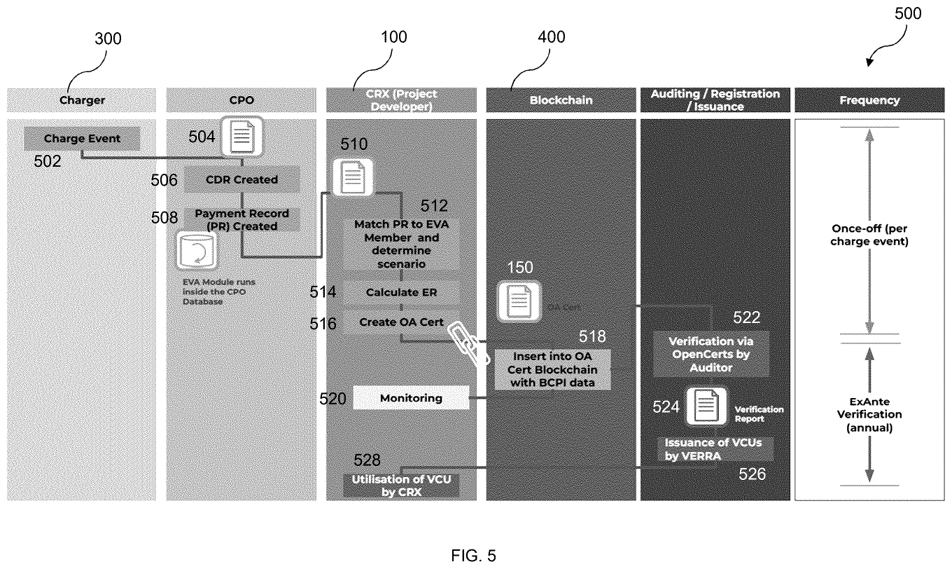

FIG. 5 shows a process 500 for generating the carbon credit certificate 150 and storing it on the blockchain 400 based on the first embodiments. In a step 502, the electric vehicle charging event occurs between the electric vehicle 200 and the charger 300. In a step 504, the CPO of the charger 300 receives information of the charging event from the charger 300, which may be based on the OCPI communications protocol. In a step 506, the CPO creates an indication of the charging event on the CPO database 110. In a step 508, the CPO creates a payment record on the CPO database 110.

In a step 510, the computer system 100 receives the indication of the charging event and the payment record from the CPO database 110, which may be based on the BCPI communications protocol. In a step 512, the computer system 100 identifies the carbon credit eligible parties using the indication of the electric vehicle charging event and/or the payment record, including whether the electric vehicle 200 and charger 300 are EVA members, to determine the appropriate carbon credit allocation scenario. In a step 514, computer system 100 calculates the amount of carbon credits, such as based on emission reduction and/or grid emission factor. In a step 516, the computer system 100 generates the carbon credit certificate 150, which may be compatible with OpenAttestation. In a step 518, the computer system 100 stores the carbon credit certificate 150 on the blockchain 400. In a step 520, the computer system 100 monitors the status of the carbon credit certificate 150 stored on the blockchain 400.

In a step 522, one or more agencies audit and verify the carbon credit certificate 150 on the blockchain 400, such as using OpenCerts. In a step 524, the agencies generate a verification report. In a step 526, the agencies issue the carbon credits, or verified carbon units (VCUs) according to international standards such as the Verra Verified Carbon Standard. In a step 528, the computer system 100 monetizes the carbon credits and disburses monies to the carbon credit eligible parties according to the carbon credit allocation scenario. The monies may include cash or cash equivalents generated from the monetization of the carbon credits. The monies may further include other benefits such as cash incentives or grants to incentive participation.

For example, the carbon credit eligible parties may include the CPO of the charger 300 and the FO of the electric vehicle 200. The monies may include 30% of the monetized carbon credits (or any appropriate percentage that may be dependent on the carbon economy and market conditions), wherein the CPO gets a portion of the 30% and the FO gets the remaining of the 30%. The monies may further include cash incentives calculated based on the amount of electricity used. The cash incentives may be distributed to the CPO and FO in the same proportions.

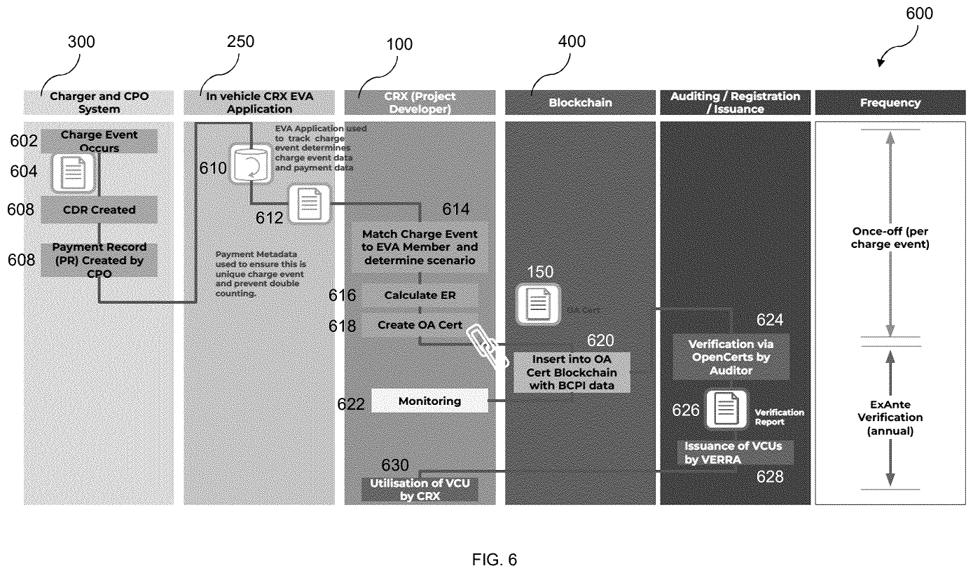

FIG. 6 shows a process 600 for generating the carbon credit certificate 150 and storing it on the blockchain 400 based on the second embodiments. In a step 602, the electric vehicle charging event occurs between the electric vehicle 200 and the charger 300. In a step 604, the CPO of the charger 300 receives information of the charging event from the charger 300, which may be based on the OCPI communications protocol. In a step 606, the CPO creates an indication of the charging event on the CPO database 110. In a step 608, the CPO creates a payment record on the CPO database 110.

In a step 610, an application running on the user device 250 or on the electric vehicle 200 stores the indication of the electric vehicle charging event and the payment record. In a step 612, the computer system 100 receives the indication of the charging event and the payment record from the application, which may be based on the BCPI communications protocol. In a step 614, the computer system 100 identifies the carbon credit eligible parties using the indication of the electric vehicle charging event and/or the payment record, including whether the electric vehicle 200 and charger 300 are EVA members, to determine the appropriate carbon credit allocation scenario. In a step 616, computer system 100 calculates the amount of carbon credits, such as based on emission reduction and/or grid emission factor. In a step 618, the computer system 100 generates the carbon credit certificate 150, which may be compatible with OpenAttestation. In a step 620, the computer system 100 stores the carbon credit certificate 150 on the blockchain 400. In a step 622, the computer system 100 monitors the status of the carbon credit certificate 150 stored on the blockchain 400.

In a step 624, one or more agencies audit and verify the carbon credit certificate 150 on the blockchain 400, such as using OpenCerts. In a step 626, the agencies generate a verification report. In a step 628, the agencies issue the carbon credits, or verified carbon units (VCUs) according to international standards such as the Verra Verified Carbon Standard. In a step 630, the computer system 100 monetizes the carbon credits and disburses monies to the carbon credit eligible parties according to the carbon credit allocation scenario.

As described above, various entities or parties such as owners of electric vehicles 200 and chargers 300 can be part of various initiatives such as the EVA project mentioned above. An entity or party may own a number of chargers 300 or a fleet of electric vehicles 200 or both. The EVA project records technical details of various scenarios, particularly the allocation of carbon credits to the owners. Each party, which can be a CPO or FO or both, that is onboarded to the EVA project is associated with a standalone Project Activity Instance (PAI). Each PAI includes details of the electric vehicles 200 and/or chargers 300 owned/operated by the respective party, as well as other project details to calculate the amount of carbon credits for the respective party. The calculation is done based on the allocation scenarios identified for the respective party. These scenarios can be scaled within the same EVA project to expand the number of electric vehicles 200 and chargers 300 in one country, as well as to other countries. Each PAI has the potential to generate up to 60,000 carbon credits or VCUs for each scenario, and targets to reduce vehicular carbon emissions in Singapore by about 3.5 million tonnes of CO2e by the year 2031 and by about 9.0 million tonnes of CO2e by the year 2040.

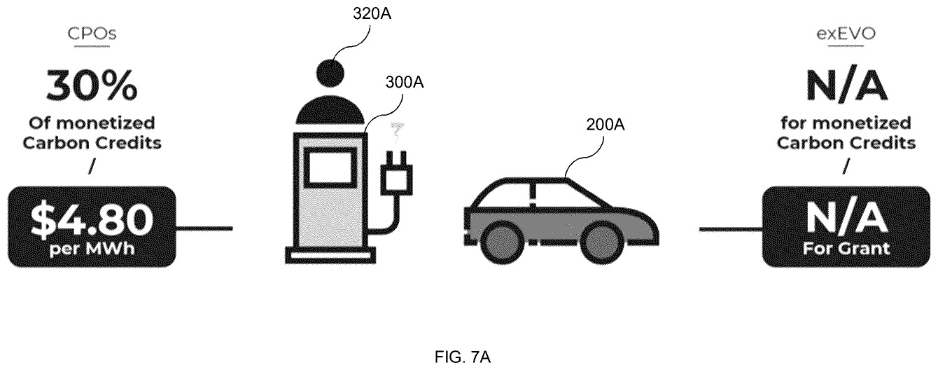

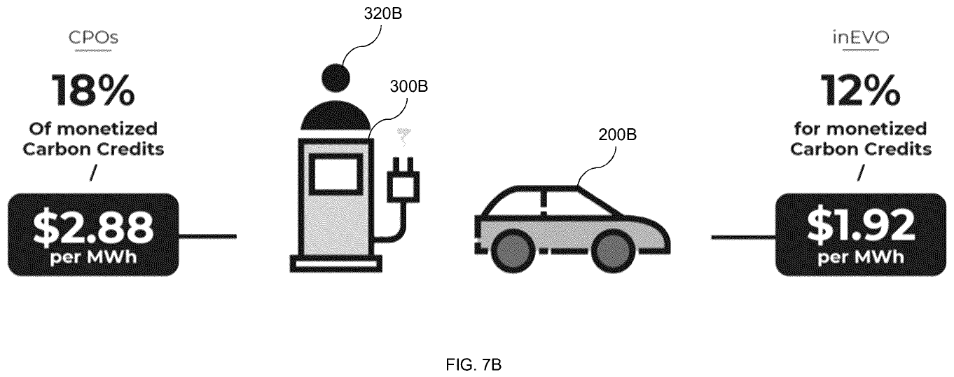

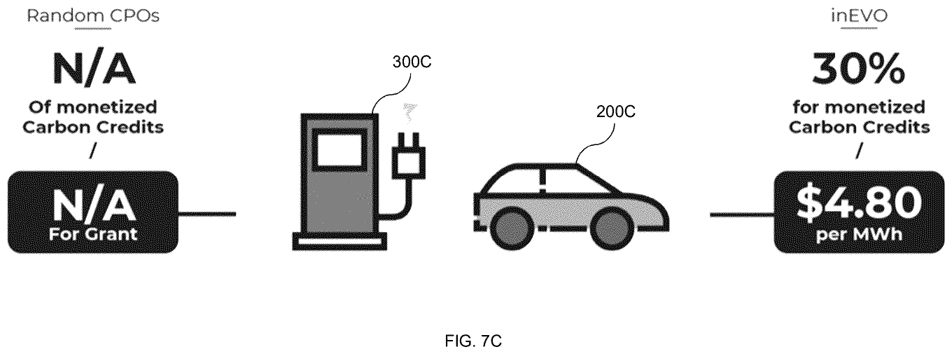

To encourage and incentivize participation in the EVA project, EVA members can receive a share of the monetized carbon credits, as well as additional incentives such as cash incentives or grants based on the charging amount, i.e. the electricity used. For example, the cash incentives may be based on predefined rates, such as $3-$4.80 per MWh of electricity used (or any appropriate rate that may be dependent on the carbon economy and market conditions). Various allocation scenarios are described below. These allocation scenarios can be broadly classified into three main scenarios as shown in FIGS. 7A to 7C.

In a first main scenario as shown in FIG. 7A, a vehicle user charges a common or random electric vehicle 200A at a charger 300A owned by a CPO 320A. The vehicle user is not registered with EVA. The CPO 320A is registered with EVA. The computer system 100 identifies the CPO 320A as the carbon credit eligible party and allocates the CPO with 30% of the monetized carbon credits. In addition, the computer system 100 allocates the CPO 320A with a cash incentive of $4.80 per MWh of electricity supplied by the charger 300A. The vehicle user does not get any carbon credits or incentives.

In a second main scenario as shown in FIG. 7B, a vehicle user charges an electric vehicle 200B at a charger 300B owned by a CPO 320B. The vehicle user and the CPO 320B are registered with EVA. The computer system 100 identifies the vehicle user and the CPO 320B as the carbon credit eligible parties. The computer system 100 allocates the vehicle user with 12% of the monetized carbon credits, and allocates the CPO 320B with 18% of the monetized carbon credits. In addition, the computer system 100 allocates the vehicle user with a cash incentive of $1.92 per MWh of electricity, and allocates the CPO 320B with a cash incentive of $2.88 per MWh of electricity.

In a third main scenario as shown in FIG. 7C, a vehicle user charges an electric vehicle 200C at a random charger 300C. The vehicle user is registered with EVA. The CPO of the charger 300C is not registered with EVA. The computer system 100 identifies the vehicle user as the carbon credit eligible party. The computer system 100 allocates the vehicle user with 30% of the monetized carbon credits. In addition, the computer system 100 allocates the vehicle user with a cash incentive of $4.80 per MWh of electricity. The CPO of the charger 300C does not get any carbon credits or incentives.

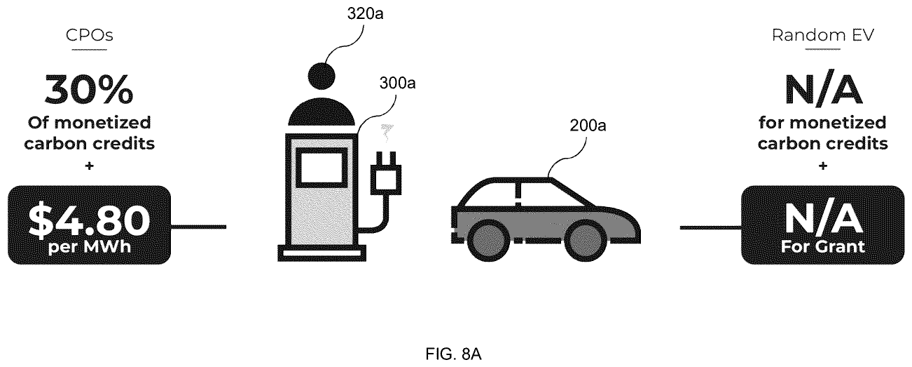

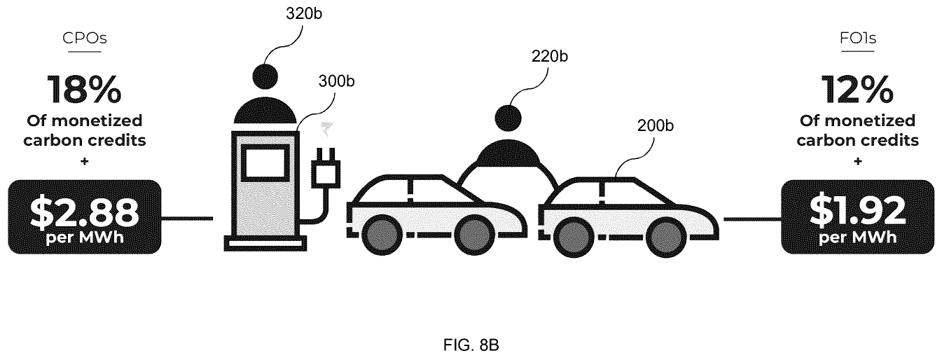

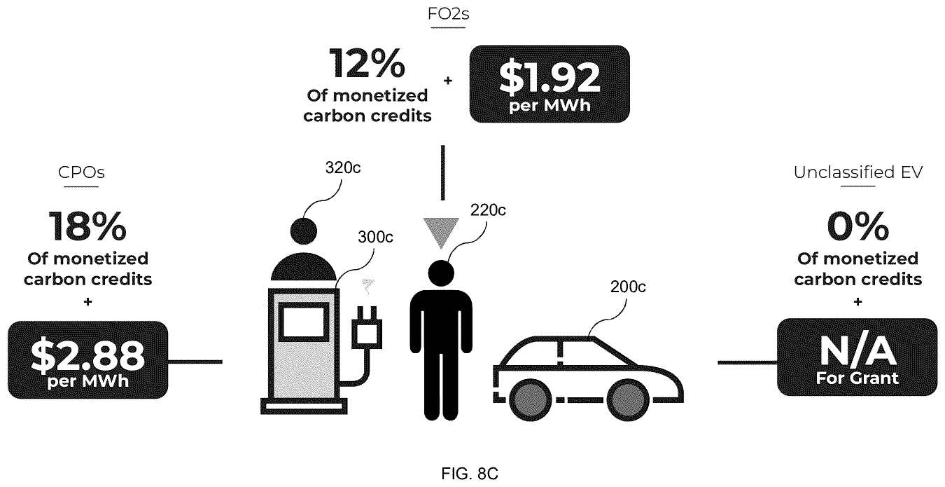

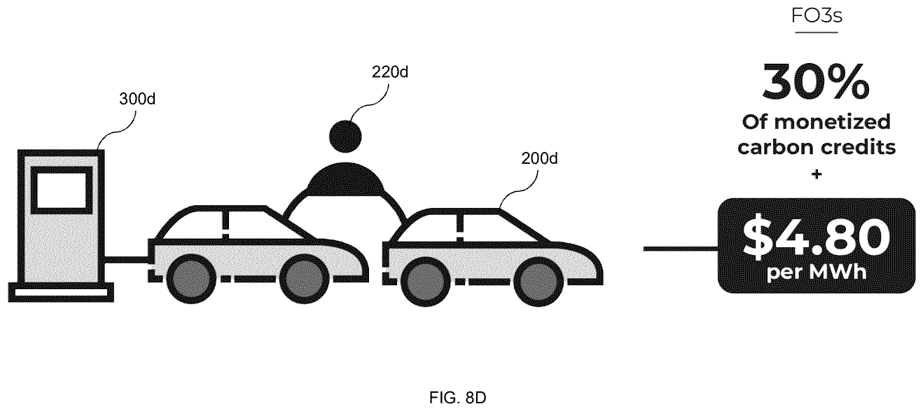

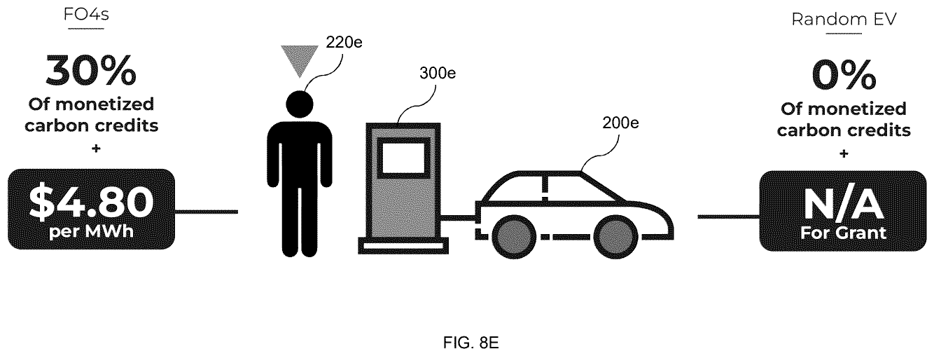

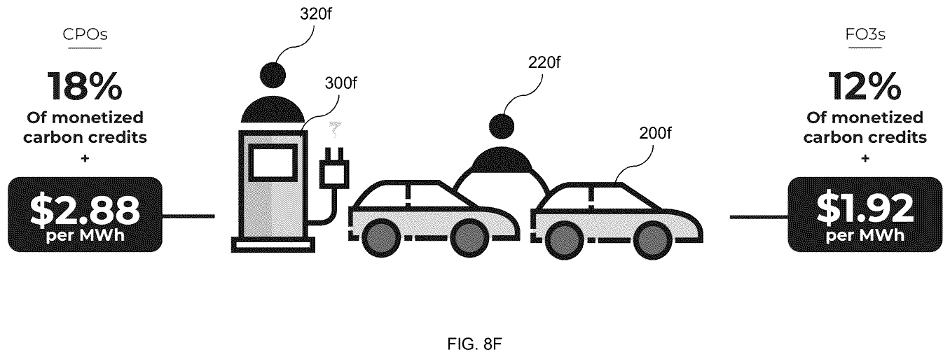

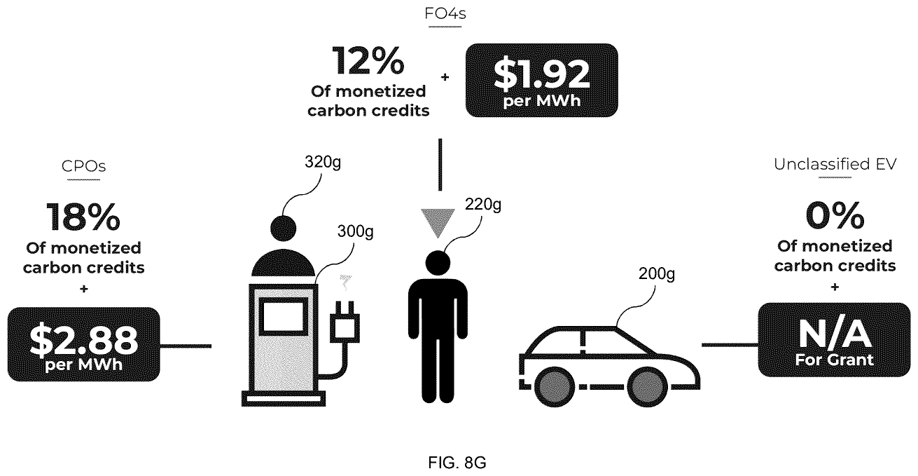

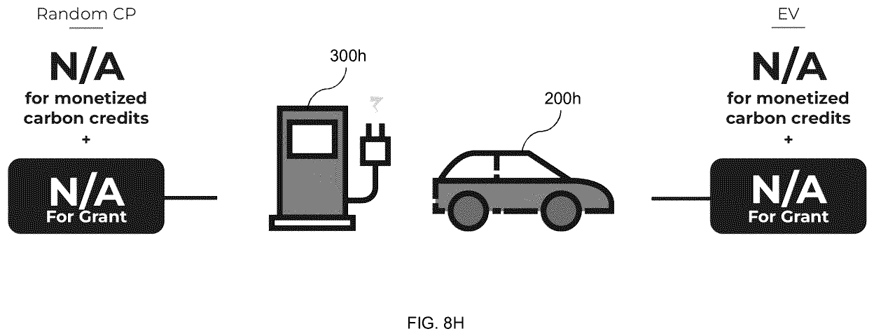

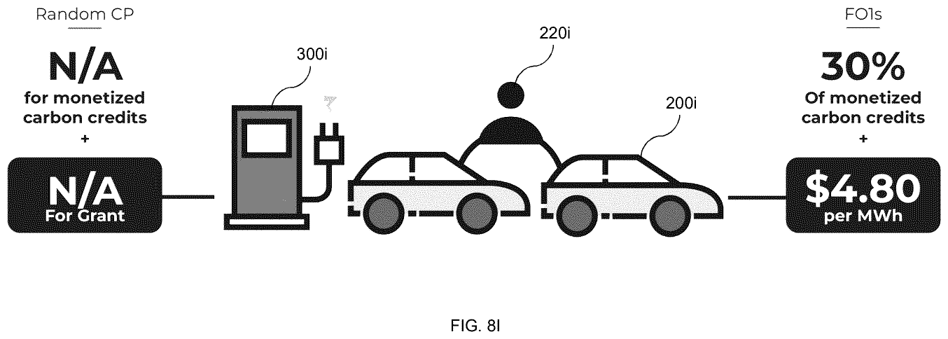

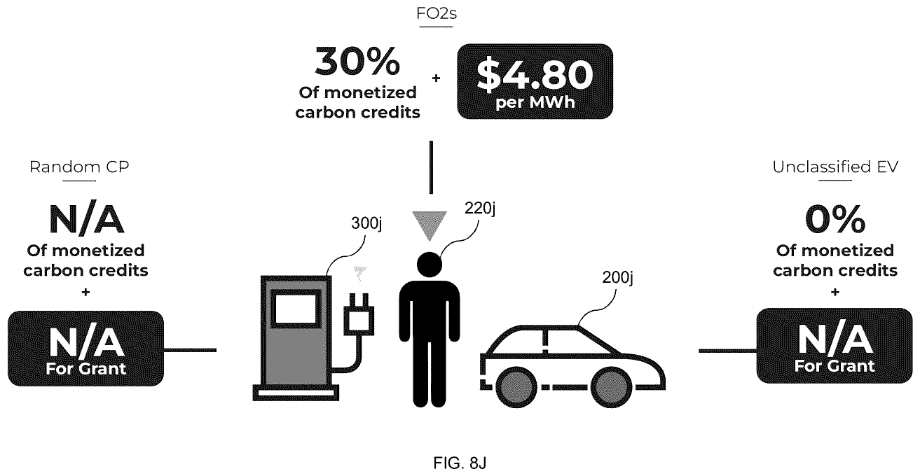

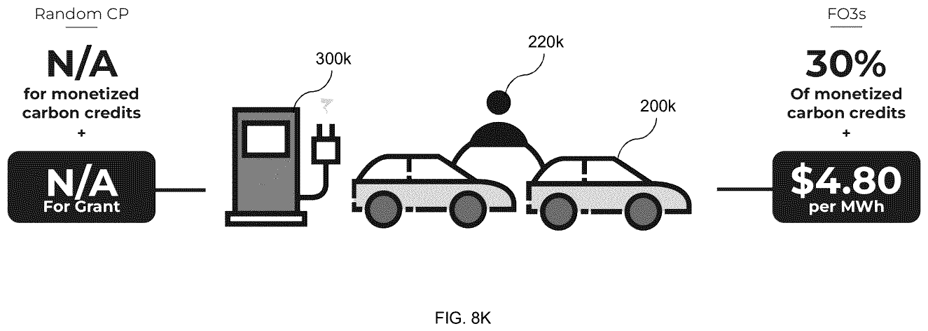

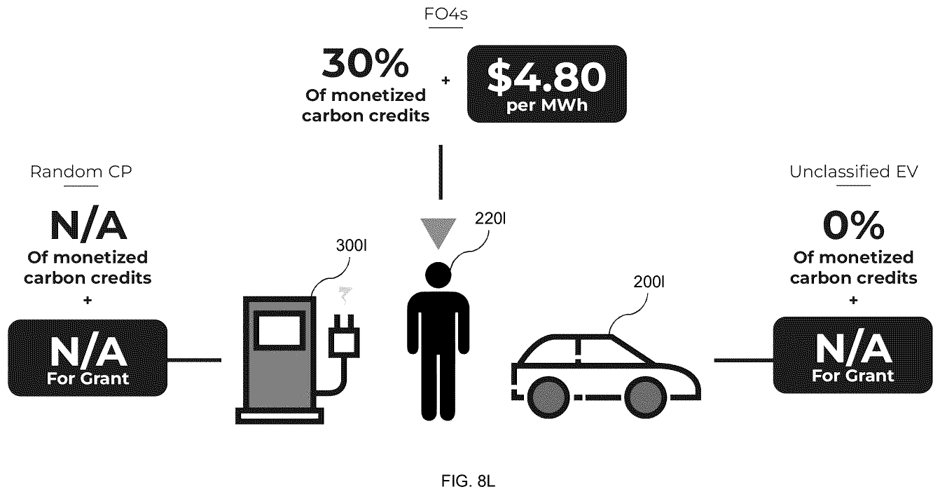

The allocation scenarios can be more specifically classified into twelve scenarios involving various types of electric vehicles 200 and chargers 300, particularly whether their respective owners/operators are registered with EVA. These scenarios are described below with reference to FIGS. 8A to 8L.

In a first scenario as shown in FIG. 8A, a vehicle user charges a random electric vehicle 200a at a charger 300a owned by a CPO 320a. The vehicle user is not registered with EVA. The CPO 320a is registered with EVA. This scenario is similar to the first main scenario as shown in FIG. 7A. The computer system 100 identifies the CPO 320a as the carbon credit eligible party and allocates the CPO with 30% of the monetized carbon credits. In addition, the computer system 100 allocates the CPO 320a with a cash incentive of $4.80 per MWh of electricity supplied by the charger 300a. The vehicle user does not get any carbon credits or incentives.

In a second scenario as shown in FIG. 8B, a fleet owner 220b (FO1) owns a number of electric vehicles 200b and charges the electric vehicles 200b at a charger 300b owned by a CPO 320b. The fleet owner 220b and the CPO 320b are registered with EVA. This scenario is similar to the second main scenario as shown in FIG. 7B. The computer system 100 identifies the fleet owner 220b and the CPO 320b as the carbon credit eligible parties. The computer system 100 allocates the fleet owner 220b with 12% of the monetized carbon credits, and allocates the CPO 320b with 18% of the monetized carbon credits. In addition, the computer system 100 allocates the fleet owner 220b with a cash incentive of $1.92 per MWh of electricity, and allocates the CPO 320b with a cash incentive of $2.88 per MWh of electricity.

In a third scenario as shown in FIG. 8C, a fleet operator 220c (FO2) operates a random electric vehicle 200c and charges the electric vehicle 200c at a charger 300b. The electric vehicle 200c is owned by another party. The fleet operator 220c and the CPO 320c are registered with EVA. The computer system 100 identifies the fleet operator 220c and the CPO 320c as the carbon credit eligible parties. The computer system 100 allocates the fleet operator 220c with 12% of the monetized carbon credits, and allocates the CPO 320c with 18% of the monetized carbon credits. In addition, the computer system 100 allocates the fleet operator 220c with a cash incentive of $1.92 per MWh of electricity, and allocates the CPO 320c with a cash incentive of $2.88 per MWh of electricity. The random electric vehicle 200c is an unclassified electric vehicle that does not accrue benefits for the owner. Instead, the benefits accrue to the fleet operator 220c of the electric vehicle 200c.

In a fourth scenario as shown in FIG. 8D, a fleet owner 220d owns a number of electric vehicles 200d and charges the electric vehicles 200d at a charger 300d. The charger 300d is also owned and operated by the fleet owner 220d (FO3). The fleet owner 220d is registered with EVA. The computer system 100 identifies the fleet owner 220d as the carbon credit eligible party. The computer system 100 allocates the fleet owner 220d with 30% of the monetized carbon credits. In addition, the computer system 100 allocates the fleet owner 220d with a cash incentive of $4.80 per MWh of electricity.

In a fifth scenario as shown in FIG. 8E, a fleet operator 220e operates a random electric vehicle 200e and charges the electric vehicle 200e at a charger 300e. The electric vehicle 200e is owned by another party. The charger 300e is owned and operated by the fleet operator 220e (FO4). The fleet operator 220e is registered with EVA. The computer system 100 identifies the fleet operator 220e as the carbon credit eligible party. The computer system 100 allocates the fleet operator 220e with 30% of the monetized carbon credits. In addition, the computer system 100 allocates the fleet operator 220e with a cash incentive of $4.80 per MWh of electricity. The random electric vehicle 200e is an unclassified electric vehicle that does not accrue benefits for the owner. Instead, the benefits accrue to the fleet operator 220e of the electric vehicle 200c.

In a sixth scenario as shown in FIG. 8F, a fleet owner 220f (FO3) owns a number of electric vehicles 200f and charges the electric vehicles 200f at a charger 300f owned by a CPO 320f. The CPO 320f is different from the fleet owner 220f which may own and operate other chargers 300. The fleet owner 220f and the CPO 320f are registered with EVA. The computer system 100 identifies the fleet owner 220f and the CPO 320f as the carbon credit eligible parties. The computer system 100 allocates the fleet owner 220f with 12% of the monetized carbon credits, and allocates the CPO 320f with 18% of the monetized carbon credits. In addition, the computer system 100 allocates the fleet owner 220f with a cash incentive of $1.92 per MWh of electricity, and allocates the CPO 320f with a cash incentive of $2.88 per MWh of electricity.

In a seventh scenario as shown in FIG. 8G, a fleet operator 220g operates a random electric vehicle 200g and charges the electric vehicle 200g at a charger 300g owned by a CPO 320g. The CPO 320g is different from the fleet operator 220g which may own and operate other chargers 300. The fleet operator 220g and the CPO 320g are registered with EVA. The computer system 100 identifies the fleet operator 220g and the CPO 320g as the carbon credit eligible parties. The computer system 100 allocates the fleet operator 220g with 12% of the monetized carbon credits, and allocates the CPO 320g with 18% of the monetized carbon credits. In addition, the computer system 100 allocates the fleet operator 220g with a cash incentive of $1.92 per MWh of electricity, and allocates the CPO 320g with a cash incentive of $2.88 per MWh of electricity. The random electric vehicle 200g is an unclassified electric vehicle that does not accrue benefits for the owner. Instead, the benefits accrue to the fleet operator 220g of the electric vehicle 200g.

In an eighth scenario as shown in FIG. 8H, a vehicle user charges a random electric vehicle 200h at a random charger 300h owned by a CPO. The vehicle user and the CPO are not registered with EVA. The computer system 100 does not identify any carbon credit eligible party. As such, no benefits are distributed in this scenario.

In a ninth scenario as shown in FIG. 8I, a fleet owner 220i (FO1) owns a number of electric vehicles 200i and charges the electric vehicles 200i at a random charger 300i owned by a CPO. The fleet owner 220i is registered with EVA. The CPO is not registered with EVA. This scenario is similar to the third main scenario as shown in FIG. 7C. The computer system 100 identifies the fleet owner 220i as the carbon credit eligible party. The computer system 100 allocates the fleet owner 220i with 30% of the monetized carbon credits. In addition, the computer system 100 allocates the fleet owner 220i with a cash incentive of $4.80 per MWh of electricity.

In a tenth scenario as shown in FIG. 8J, a fleet operator 220j (FO2) operates a random electric vehicle 200j and charges the electric vehicle 200j at a random charger 300j owned by a CPO. The electric vehicle 200j is owned by another party. The fleet operator 220j is registered with EVA. The CPO is not registered with EVA. The computer system 100 identifies the fleet operator 220j as the carbon credit eligible party. The computer system 100 allocates the fleet operator 220j with 30% of the monetized carbon credits. In addition, the computer system 100 allocates the fleet operator 220j with a cash incentive of $4.80 per MWh of electricity. The random electric vehicle 200j is an unclassified electric vehicle that does not accrue benefits for the owner. Instead, the benefits accrue to the fleet operator 220j of the electric vehicle 200j.

In an eleventh scenario as shown in FIG. 8K, a fleet owner 220k (FO3) owns a number of electric vehicles 200k and charges the electric vehicles 200k at a random charger 300k owned by a CPO. The CPO is different from the fleet owner 220k which may own and operate other chargers 300. The fleet owner 220k is registered with EVA. The CPO is not registered with EVA. The computer system 100 identifies the fleet owner 220k as the carbon credit eligible party. The computer system 100 allocates the fleet owner 220k with 30% of the monetized carbon credits. In addition, the computer system 100 allocates the fleet owner 220k with a cash incentive of $4.80 per MWh of electricity.

In a twelfth scenario as shown in FIG. 8L, a fleet operator 220l (FO4) operates a random electric vehicle 200l and charges the electric vehicle 200l at a random charger 300l owned by a CPO. The electric vehicle 200l is owned by another party. The CPO is different from the fleet operator 220l which may own and operate other chargers 300. The fleet operator 220l is registered with EVA. The CPO is not registered with EVA. The computer system 100 identifies the fleet operator 220l as the carbon credit eligible party. The computer system 100 allocates the fleet operator 220l with 30% of the monetized carbon credits. In addition, the computer system 100 allocates the fleet operator 220l with a cash incentive of $4.80 per MWh of electricity. The random electric vehicle 200l is an unclassified electric vehicle that does not accrue benefits for the owner. Instead, the benefits accrue to the fleet operator 220l of the electric vehicle 200l.

The computer system 100 and computer implemented method described in various embodiments herein provide generation of compliant carbon credits for eligible parties, such as FOs of electric vehicles 200 and CPOs of electric vehicle chargers 300, in accordance with international standards. Each electric vehicle charging event is uniquely identified through the indication of the event itself and/or the payment record associated therewith. This mitigates the risk of double counting of carbon credits. Further, a carbon credit certificate 150 is issued to certify the amount of carbon credits generated. The carbon credit certificate 150 indicates the eligible parties and the amount of carbon credits allocated to them. The carbon credit certificate 150 may optionally be stored on the blockchain 400 to provide an immutable record of the carbon credits that have been allocated and eventually monetized.

In the foregoing detailed description, embodiments of the present disclosure in relation to methods and systems for certifying carbon credits for electric vehicle charging are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computer implemented method for certifying carbon credits for electric vehicle charging, the method comprising:
receiving an indication of an electric vehicle charging event and a payment record corresponding to the electric vehicle charging event;
identifying one or more carbon credit eligible parties using the indication of the electric vehicle charging event and/or the payment record;
calculating an amount of carbon credits for the electric vehicle charging event using the indication of the electric vehicle charging event; and
generating a carbon credit certificate indicating the one or more carbon credit eligible parties, the amount of carbon credits, and a unique identifier of the electric vehicle charging event.

2. The method according to claim 1, wherein the indication of the electric vehicle charging event and the payment record corresponding to the electric vehicle charging event are received from an electric vehicle charger.

3. The method according to claim 1, wherein the indication of the electric vehicle charging event and the payment record corresponding to the electric vehicle charging event are received from an application running on a user device or on an electric vehicle.

4. The method according to claim 1, further comprising verifying that the payment record corresponds to the electric vehicle charging event.

5. The method according to claim 4, wherein verifying that the payment record corresponds to the electric vehicle charging event comprises comparing metadata of the payment record with the indication of the electric vehicle charging event.

6. The method according to claim 1, wherein identifying the one or more carbon credit eligible parties using the indication of the electric vehicle charging event and/or the payment record comprises determining a billing identifier from the payment record and using the billing identifier to look up a record in database corresponding to a billed party.

7. The method according to claim 6, wherein the record in database corresponding to the billed party indicates a carbon credit allocation scenario and the one or more carbon credit eligible parties are identified according to the carbon credit allocation scenario.

8. The method according to claim 7, further comprising monetizing the carbon credits and disbursing monies to the according to the one or more carbon credit eligible parties according to the carbon credit allocation scenario.

9. The method according to claim 1, wherein calculating the amount of carbon credits for the electric vehicle charging event using the indication of the electric vehicle charging event comprises: determining a charging amount from the indication of the electric vehicle charging event and a grid emission factor corresponding to an electric vehicle charger associated with the charging event; and
calculating the amount of carbon credits from the charging amount and the grid emission factor.

10. The method according to claim 1, further comprising storing the carbon credit certificate on a blockchain.

11. The method according to claim 10, further comprising verifying the carbon credit certificate on the blockchain.

12. A computer system comprising a processor and a data storage device, the data storage device storing computer program instructions operable to cause the processor to perform the method according to claim 1.
